(19) United States
(12) Patent Application Publication
(10) Pub. No.: US 2017/0370077 A1
(43) Pub. Date: Dec. 28, 2017

(54) TEMPERATURE-LIMITING VALVE ASSEMBLY WITH HIGH TEMPERATURE SANITARY FLUSHING MODE

(71) Applicants: Paul Schmitt, Hawthorn Woods, IL (US); Prasert Buranatum, Skokie, IL (US)

(72) Inventors: Paul Schmitt, Hawthorn Woods, IL (US); Prasert Buranatum, Skokie, IL (US)

(21) Appl. No.: 15/191,315

(22) Filed: Jun. 23, 2016

(51) Int. Cl. E03C 1/04; F16K 31/60

(52) U.S. Cl. CPC E03C 1/041; F16K 31/605

(57) ABSTRACT

A temperature limiting valve assembly and its associated limiting arrangement are provided. The temperature limiting valve assembly includes a valve body and the limiting arrangement installed on the valve body. The limiting arrangement includes a limiting member and clip removably installed on the limiting member. The clip defines a limiting position of the valve assembly. The limiting position denotes the maximum output flow temperature of the valve assembly. Removal of the clip also removes the aforementioned limiting position of the valve to allow a temperature output flow which is greater than the maximum output flow for purposes of sanitation.

### FIELD OF THE INVENTION

This invention generally relates to valves and more particularly to temperature limiting valves.

### BACKGROUND OF THE INVENTION

Temperature-limiting valves are used to prevent a user from being scalded by high temperature water resulting from the temperature control, typically the associated handle, on a valve being turned too far toward the maximum hot position. They are necessary because typically hot water supplies are far hotter than even the hottest temperature that a user will be using in a sink faucet application or in a shower application. Such thermostatic temperature-limiting valves typically have a temperature-responsive element that limits the flow of hot water in order to maintain the outlet water temperature at or below a predetermined temperature.

Some temperature-limiting valve may also have a mechanical adjustment mechanism that can be used to adjust the maximum temperature of water supplied by the valve, typically by adjusting the limiting position of the temperature control which as stated above may be a handle. An example of such a valve is shown in U.S. Pat. No. 7,163,157 the teachings and disclosure of which are incorporated by reference herein.

In certain settings, it may be necessary to disable the temperature limiting functionality of such valves. As one example of many, a health care facility must periodically sanitize their water lines. This can be done by directing very high temperature water through the lines. However, to achieve this operation, the temperature limiting functionality of the valves at the outputs of the lines, e.g. showers, sinks, etc., must be disabled. While such an operation has proven an effective mechanism for sanitization, it is not without drawbacks.

As one drawback, existing temperature limiting valves are relatively complex in their construction. As a result, to disable the temperature limiting functionality, especially on those valves which include the above mentioned mechanical adjustment mechanism can be quite complex. Typically, a significant portion of the valve must be disassembled to disable its temperature limiting functionality, i.e. to place the valve into a sanitation flush mode. The valve must then be temporarily reassembled to allow the operator to adjust the valve setting so that very hot water is directed through the valve and water lines associated therewith. After the sanitization operation is complete, another disassembly and subsequent reassembly are required to place the valve back in its normal operating configuration.

As another drawback, there is a risk that an operator conducting the sanitization operation may forget to replace the temperature limiting componentry of the valve. As a result, a subsequent user may be scalded by the very hot water allowed to flow through the system.

Accordingly, there is a need in the art for a temperature limiting valve with a high temperature sanitation flush mode which may be easily transitioned for sanitation operations. The invention provides such a valve and associated componentry. These and other advantages of the invention, as well as additional inventive features, will be apparent from the description of the invention provided herein.

### BRIEF SUMMARY OF THE INVENTION

In one aspect, the invention provides a temperature limiting valve assembly that can be rapidly transitioned into a sanitation flush mode in an efficient manner without significant disassembly of the temperature limiting valve assembly. An embodiment according to this aspect includes a valve body. The valve body has a housing which defines at least one inlet and at least one outlet. A valve member is arranged within the housing and operable to control a flow along a flow path between the at least one inlet and the at least one outlet. The valve body also includes a valve stem. The valve stem is mechanically coupled to the valve member to position the valve member in a desired position relative to the flow path. The valve stem defines a first abutment surface. This embodiment of the temperature limiting valve assembly also includes a limiting arrangement. The limiting arrangement includes a limiting member which surrounds the valve stem. The valve stem is linearly and rotationally moveable within a cavity defined by the limiting member. The limiting arrangement also includes a clip removably mounted relative to the limiting member. The clip defines a second abutment surface. The second abutment surface is arranged for abutment with the first abutment surface of the valve stem at a limit position to prevent continued linear movement in a first direction of said valve stem within the cavity of the limiting member.

The at least one inlet may include a hot water inlet and a cold water inlet. Hot water from the hot water inlet and cold water from the cold water inlet are mixed within the valve body to produce an outlet flow at the at least one outlet. A temperature of the outlet flow is determined by the position of the valve stem relative to the housing. The limit position defines a maximum temperature of the output flow.

The valve stem has a first diameter and a second diameter which is less than the first diameter. The first abutment surface is defined at a transition from the first diameter to the second diameter. The clip includes a valve stem receiving portion. The valve stem receiving portion defines a third diameter which is less than the first diameter and greater than the second diameter. The clip is resiliently deformable to an expanded position. In the expanded position, the valve stem receiving portion defines a fourth diameter which is at least as large as the first diameter.

The limiting member has a generally cylindrical outer periphery and includes a pair of opposed slots formed in said generally cylindrical outer periphery. The clip has an open side such that it has a pair of opposed leg portions. The pair of opposed leg portions are received, respectively, in the pair of opposed slots of the limiting member. The clip includes a valve stem receiving portion. The valve stem receiving portion is disposed between the pair of opposed leg portions. The pair of opposed leg portions are resiliently deformable toward and away from one another to vary a size of the valve stem receiving portion.

In another aspect, the invention provides a temperature limiting valve assembly which reduces the risk that the temperature limiting functionality of the valve will not be re-enabled after a sanitation flushing operation. An embodiment according to this aspect includes a valve body. The valve body has a housing defining at least one inlet and at least one outlet. A valve member is arranged within the housing and arranged to control a flow along a flow path between the at least one inlet and the at least one outlet. The valve body also includes a valve stem. The valve stem is mechanically coupled to the valve member to position the valve member in a desired position relative to the flow path. The valve stem defines a first abutment surface.

This embodiment also includes a limiting arrangement. The limiting arrangement includes a limiting member surrounding the valve stem. The valve stem is linearly and rotationally moveable within a cavity defined by the limiting member. The limiting arrangement also includes a clip. The clip defines a second abutment surface. The clip is resiliently deformable to prevent movement of the first abutment surface past the second abutment surface in a first direction, and permit movement of the first abutment surface past the second abutment surface in a second direction opposite the first direction.

The clip is resiliently deformable to an expanded position. In the expanded position, a diameter of a valve stem receiving portion of the clip increases. The valve stem has a first diameter and a second diameter. The first abutment surface is formed at a transition from the first diameter to the second diameter. When the clip is not in the expanded position, a portion of the valve stem defining the second diameter passes through the clip. The clip may be removably mounted relative to the limiting member in this embodiment.

In yet another aspect, the invention provides a temperature limiter which may be installed on an existing valve to allow for rapid transitioning of the valve into a sanitation flush mode, and also reduce the risk that the temperature limiting functionality of the valve will not be re-enabled after the sanitation flushing is complete. An embodiment according to this aspect includes a limiting member. The limiting member defines an internal cavity. The internal cavity is configured for receipt of a valve stem of the valve. The temperature limiter also includes a clip removably mounted relative to the limiting member. The clip has an installed position and an uninstalled position. In the installed position, an abutment surface of the clip is positioned within the internal cavity and is arranged to permit linear movement of the valve stem in a first direction past a limit position. In the uninstalled position, the abutment surface is not positioned within the internal cavity.

The limiting member has a generally cylindrical outer periphery and includes a pair of opposed slots formed in said generally cylindrical outer periphery. The clip has an open side such that it has a pair of opposed leg portions. The pair of opposed leg portions are received, respectively, in the pair of opposed slots.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of an exemplary embodiment of a valve assembly according to the teachings of the present invention;

FIG. 2 is a perspective exploded view of the valve assembly of FIG. 1;

FIG. 3 is a perspective view of a portion of the valve assembly of FIG. 1; and

FIGS. 4-6 are perspective cross sections of the valve assembly of FIG. 1.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

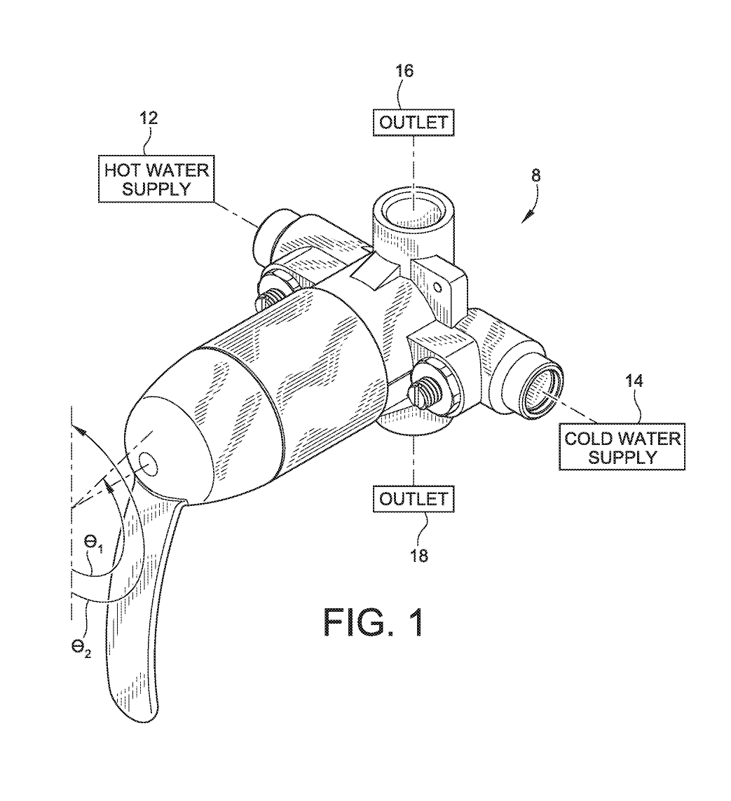

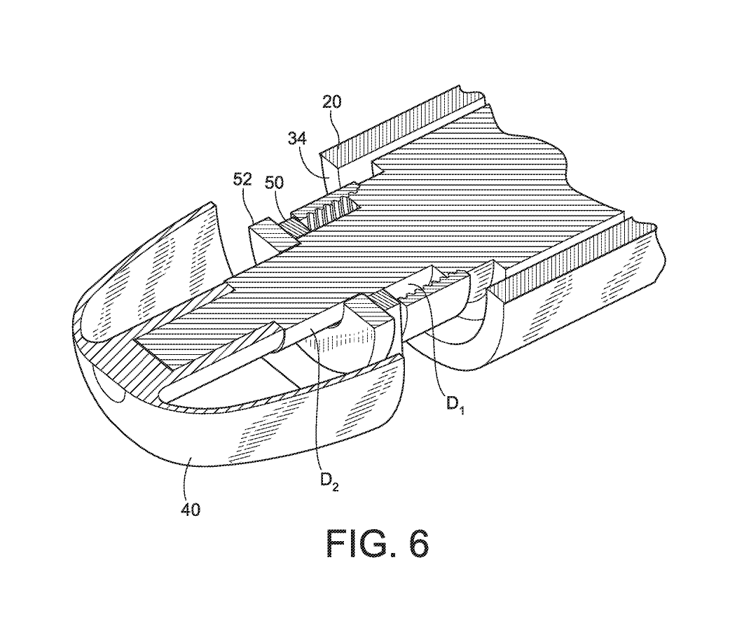

Turning now to the drawings, FIGS. 1-6 illustrate an exemplary embodiment of a temperature limiting valve assembly 8 according to the teachings of the present invention. As will be understood from the following, the temperature limiting valve assembly 8 advantageously overcomes existing problems in the art by allowing for rapid transitioning of the valve assembly 8 from its normal operational mode to a sanitation flush mode. Additionally, the valve assembly 8, and more particularly a limiting arrangement thereof, reduces the risk that an operator will forget to re-enable the temperature limiting functionality of the valve assembly 8 once the sanitation flushing operation is complete.

With particular reference to FIG. 1, valve assembly 8 is illustrated schematically installed in an exemplary operational environment. Indeed, valve assembly 8 is connected to a hot water supply 12 and a cold water supply 14. Water from these supplies is mixed within valve assembly 8 to produce an output flow which is directed to outlets 16, 18. As an example, outlet 16 may be a shower head, while outlet 18 may be a bath tub spout. It will be readily recognized that while two outlets 16, 18 are shown, valve assembly 8 need only contain at least one outlet.

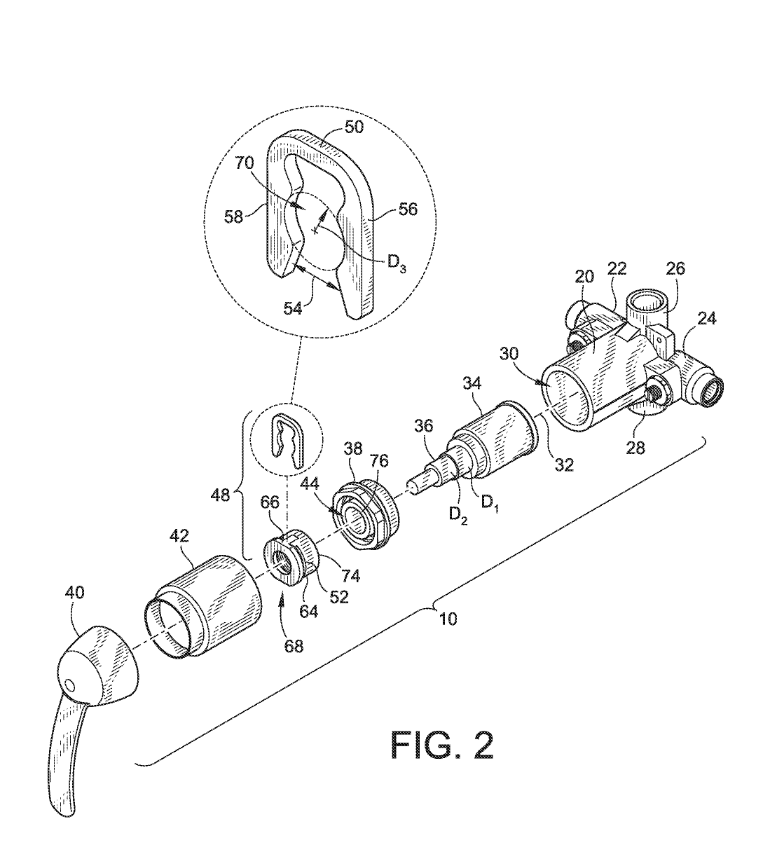

As will be discussed more fully below, valve assembly 8 includes a valve body 10 (see FIG. 2) and limiting arrangement (also referred to herein as a temperature limiter) installed on valve body 10 which defines a limit position of valve assembly 8. This limit position in turn defines a maximum temperature of an outlet flow of valve assembly 8. Indeed, valve assembly includes a handle as shown. As this handle is rotated counter clockwise relative to FIG. 1, the temperature of the outlet flow increases. When enabled, the limiting arrangement allows for a maximum rotation of an angle of θ₁ of the handle. The limiting arrangement thus prevents increasing the temperature of the outlet flow beyond this limit position. When not enabled, the limiting arrangement does not restrict rotation of the handle, and thus the same may be rotated to a greater angle, e.g. θ₂, which allows for an increase in the temperature of the outlet flow to a temperature satisfactory for sanitation flushing of the exemplary operational environment.

It will be readily recognized from the following, that the particular embodiment of the valve body 10 illustrated is non-limiting on the invention. Indeed, the limiting arrangement described below may be installed on any valve which utilizes a helical style valve stem actuation, i.e. a valve stem which rotates and moves linearly to achieve the mixing function described above.

Turning now to FIG. 2, valve body 10 and the aforementioned limiting arrangement will be described in greater detail. FIG. 2 illustrates an exploded view of the valve body 10 as well as an exploded view of the aforementioned limiting arrangement relative to valve body 10. Valve body 10 includes a valve housing 20. Valve housing 20 includes a hot water inlet which connects to hot water supply 12 (see FIG. 1), as well as a cold water inlet 24 which connects to the cold water supply 14 (see FIG. 1). Additionally, valve housing 20 includes outlet ports 26, 28 which respectively connect to outlets 16, 18 (see FIG. 1). Valve housing 20 also includes an internal cavity 30. A flow path extends from each of the aforementioned inlets 22, 24 to the outlets 26, 28 via cavity 30. Although not required, inlets 22, 24 can also include adjustment screws which extend parallel to valve axis 32. Each adjustment screw may be utilized to close off its respective inlet 22, 24. This is advantageous for the sanitation flush mode of valve assembly 8 as it allows a user to fully close off the flow of cold water to maximize the outlet temperature of valve assembly 8. These adjustment screws may be accessed via a port in a trim plate (not shown) or by removal of the trim plate.

Cavity 30 defines a valve access 32 about which a valve member 34 (also referred to by those of skill in the art as a cartridge) and a valve stem 36 mechanically coupled to valve member 34 are rotatable about. Valve member 34 is schematically shown as any number of valve member arrangements may be utilized to control the flow along the above-introduced flow path. Valve stem 36 is a shaft-like component. It has a first portion at a first diameter D₁ and a second portion at a second diameter D₂. An end portion extends away from the second portion to provide a mounting location for a handle 40 of valve body 10. As is generally understood in the art, and applied to work at the handle 40 is transferred valve stem 36 and in turn to valve member 34.

A valve cap 38 seals valve member 34 within cavity 30. Shaft 36 extends through a bore 44 formed in valve cap 38 to allow for connection of handle 40. Additionally, a cosmetic covering 42 may also be included to shroud or otherwise cover portions of valve body 10, including valve cap 38 and the connection interface between handle 40 and valve stem 36.

Turning now to the limiting arrangement of valve assembly 8, as introduced above, the same is installed on valve body 10. Limiting arrangement 48 includes a clip 50 which is removably mounted relative to a limiting member 52. As will be understood from the following, clip 50 is physically attached to valve stem 36 and can be selectively removed therefrom, thereby making it removably mounted relative to the limiting member 52. It is also envisioned that clip 50 may be removably mounted relative to limiting member 52 via a direct engagement between clip 50 and limiting member 52. In such an embodiment, limiting member 52 may include tabs or other structures which opposed leg portions 56, 58 interlock with to hold it in place on limiting member 52.

Indeed, clip 50 includes an opening 54 and a pair of opposed leg portions 56, 58. Leg portions 56, 58 are resiliently deformable toward and away from one another to decrease and increase a diameter D₃ defined by a shaft receiving portion 70 of clip 50. As will be understood from the following, this resilient deformability of clip 50 allows clip 50 to accommodate diameter D₂ as well as diameter D₁ of valve stem 36. It will be understood, however, that the shaft receiving portion 70 may need not define a diameter, i.e. take on a fully or partially circular shape. Indeed, the size and shape of shaft receiving portion 70 need only be such that it has a maximum dimension which is between the values of diameters D₁ and D₂. Indeed, a rectangular cut out could be employed for shaft receiving portion 70 as one of many examples. Clip 50 may be formed in any manner to achieve its functionality described herein. As non-limiting examples, clip 50 may be a molded component, a stamped metal component, or formed from bent wire.

Limiting member 52 has a generally cylindrical outer periphery. A pair of opposed slots 64, 66 are formed in this outer periphery. These slots 64, 66 communicate with a bore 68 extending through limiting member 52. Slots 64, 66 receive leg portions 56, 58 (dictated 56, 58) of clip 50. As a result, a portion of each leg portion 56, 58 is disposed within in bore 68 of limiting member 52. Limiting member 52 also includes a threaded end 74 which threadably attaches to a hub 76 formed on valve cap 38.

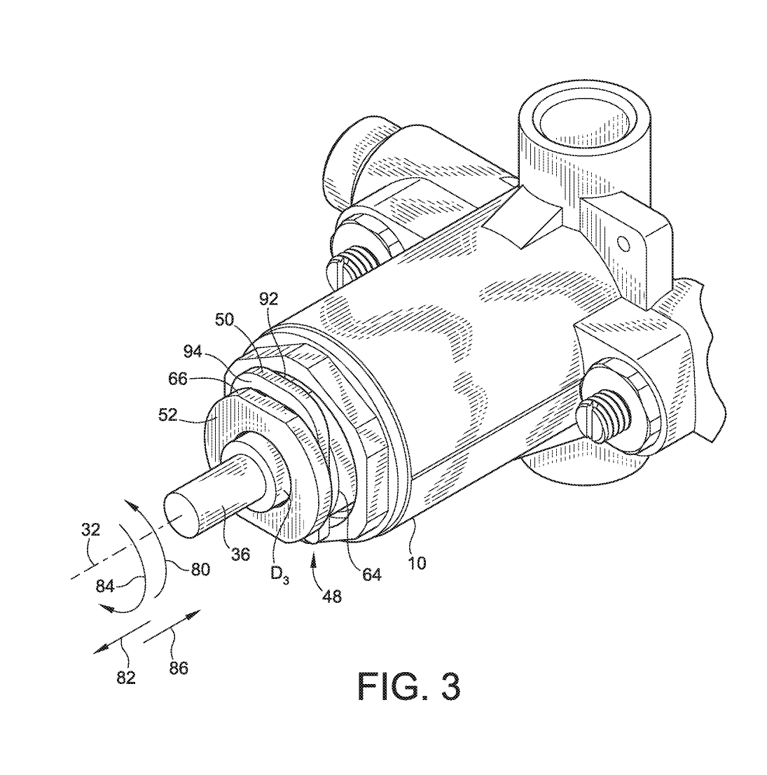

Turning now to FIG. 3, valve body 10 is illustrated with limiting arrangement 48 installed thereon. Handle 40 and cosmetic covering 42 (see FIG. 2) have been removed in this view for purposes of clarity. As introduced above, valve member 34 and valve stem 36 utilize a helical style actuation. As a result, rotation of valve stem 36 about valve access 32 in rotational direction 80 also results in linear movement of valve stem 36 relative to valve body 10 in linear direction 82. Likewise, rotation of valve stem 36 about valve access 32 in rotational direction 84 also results in a linear movement of valve stem 36 relative to valve body 10 in linear direction 86.

As can be seen in FIG. 3, clip 50 is installed on limiting member 52. The second portion of valve stem 36 at diameter D₂ extends through the bore 48 of limiting member 52, as well as through the valve stem receiving portion 70 of clip 50 when clip 50 is not in an expanded position as a result of the resilient deformation of leg portions 56, 58 (see FIG. 2) away from one another. When not in the expanded position, the diameter D₃ defined by valve stem receiving portion 70 is such that it is smaller than the diameter D₁ of valve stem 36. Accordingly, continued linear movement in linear direction 82 of valve stem 36 will bring a first abutment surface defined at the transition in between diameter D₁ and diameter D₂ into abutment with a second abutment surface defined by clip 50 as discussed below. Such a configuration prevents further movement of valve stem 36, and thus also prevents any further increase in the temperature of the outlet flow from valve body 10.

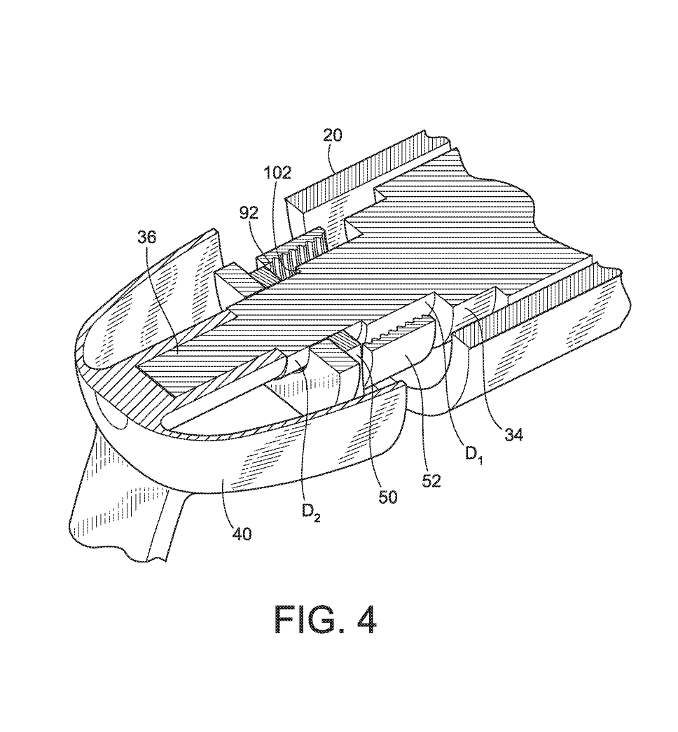

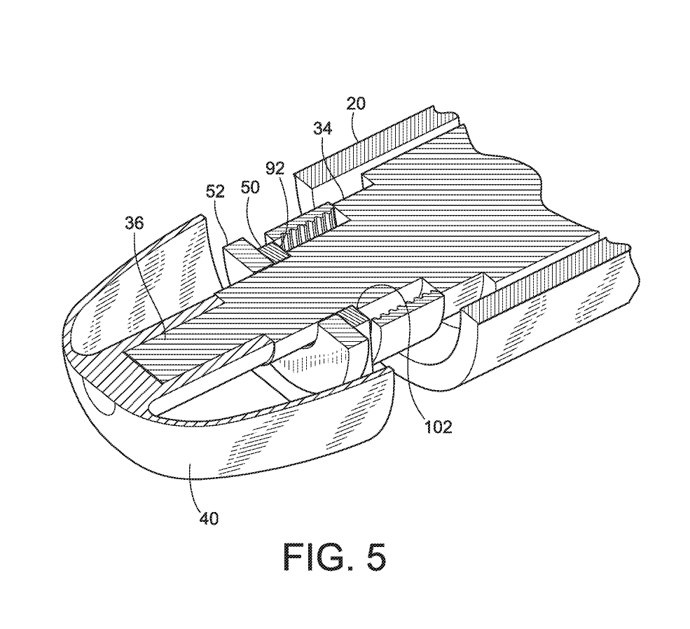

Turning now to FIGS. 4-6 the same illustrate the various stages of the aforementioned functionality. It will be noted that in these views, valve cap 38 has been removed for purposes of clarity in illustration. With particular reference to FIG. 4, as can be seen in this cross-sectional view, clip 50 extends through limiting member 52 as described above. The first abutment surface 102 formed on valve stem 36 is spaced apart from the second abutment surface 92 of clip 50. As a result, a force may be applied to handle 40 to rotate valve stem 36 about valve axis 32 in rotational direction 80 (see FIG. 3) to increase the temperature of the outlet flow from valve body 10. Turning now to FIG. 5, this rotation may continue until first abutment surface 102 encounters second abutment surface 92 as illustrated in FIG. 5. Such an abutment defines the limit position introduced above of valve assembly 10. Further rotation of valve stem 36 is prevented, and as such, increasing the temperature of the outlet flow of valve body 10 is also prevented. As can be understood from the discussion herein, the configuration shown in FIGS. 4 and 5 are those germane to the normal operation of valve assembly 8. In an alternative embodiment, the clip 50 thickness and/or shape may be such that first abutment surface 102 encounters second abutment surface 92 prior to diameter D₁ encountering limiting member 52, e.g. prior to entering bore 68.

However, when it is desirable to place valve assembly 8 into a sanitation flush mode to allow for increase in the temperature of the outlet flow from valve body 10 beyond that permitted by the aforementioned limiting position, clip 50 must be temporarily removed from limiting member 52. Once removed, valve stem 36 may continue to rotate about valve axis 32 in rotational direction 80 to an angle of Θ₂ (see FIG. 1) wherein first abutment surface 102 encounters a shoulder at the axial end of limiting member 52. The aforementioned shoulder, however, is not necessary and may be omitted to permit a greater value for angle Θ₂. In such an alternative configuration, the diameter of bore 68 (see FIG. 2) would be increased to allow first abutment surface 102 to protrude axially from bore 68 as opposed to being stopped by the aforementioned shoulder. In either case, this advantageously allows for high temperature water to flow through valve assembly 10 and its associated conduit to sanitize these components.

Advantageously, clip 50 is resiliently deformable as described above such that leg portions 56, 58 (see FIG. 3) may be biased away from one another such that valve stem receiving portion 70 (see FIG. 3) may receive the first portion of valve stem 36 at diameter D₁. In other words, an operator may remove clip 50 and rotate valve stem 36 via handle 40 to place valve assembly 8 into a sanitation flush mode where very high temperature water flows therethrough. Immediately after this rotation, the operator may replace clip 50 back on to limiting member 52 and around valve stem 36 due to its resilient deformability. When the sanitation flushing operation is complete, the operator simply rotates valve stem 36 in rotational direction 84 (see FIG. 3) to transition valve body 10 into a fully off position as valve stem 36 rotates in rotational direction 84 and moves in linear direction 86, the first portion of valve stem 36 at diameter D₁ will pass back through valve stem receiving portion 70 of clip 50. Thereafter, leg portions 56, 58 of clip 50 (see FIG. 2) will resiliently move back toward one another to decrease the diameter D₃ of shaft receiving portion 70. In this position, only the second portion at diameter D₂ of valve stem 36 may be accommodated within valve stem receiving portion 70 of clip 50 in its un-expanded position. In an alternative embodiment, clip 50 may be biased towards its unexpanded position by any type of resilient force, e.g. a clasp, wherein removal of this force cases clip 50 to return to its expanded position.

Put differently, when not in its expanded position, valve stem receiving portion 70 of clip 50 will not permit movement of the first abutment surface 102 past the second abutment surface 92 in direction 82 (see FIG. 3). However, when clip 50 is in the expanded position, second abutment surface 102 can move past first abutment surface 92 in linear direction 86 (see FIG. 3).

Although limiting arrangement 48 has been described in context of valve body 10 illustrated herein, it is contemplated by the invention herein that limiting arrangement 48 may be provided as a stand-alone sub assembly which may be retrofit on an existing valve assembly or valve body. Indeed, the embodiment of the limiting arrangement described herein may readily work with any valve stem which employs a helical style actuation. Limiting member 52 need only thread onto such an existing valve body. Further, other mechanical means of joining limiting member 52 to such an existing valve body could be employed. For example, limiting member 52 could be joined to an existing valve body 10 such that it surrounds the valve stem thereof as described herein by the use of a snap fit, a friction fit, fasteners, etc.

It will be recognized that such a configuration allows an operator to immediately replace clip 50 after removing it to thereby reduce the risk that the operator will forget to replace clip 50 at a later time. This configuration ultimately reduces the risk that a subsequent user will accidentally scald themselves with very high temperature water not intended for normal use.

Indeed, in a typical method of use, handle 40 and cosmetic covering 42 are removed from valve assembly 8. Clip 50 is then removed from limiting member 52. Handle 40 may then be replaced onto valve stem 36. The valve stem is then rotated in rotational direction 80 to a position desirable for sanitation. Once rotated, clip 50 may be immediately reinstalled in limiting member 52. After completion of the sanitation operation, handle 40 may be rotated in rotational direction 84 to place valve assembly 8 in a fully off position. By doing so, clip 50 will be returned to its non-expanded position. Thereafter, cosmetic covering 42 may be replaced and valve assembly 8 will be ready for normal operation and usage.

From the description of the typical method of use above, it will be readily recognized that the transitioning of valve assembly 8 into a sanitation flush mode is an efficient operation which does not require significant disassembly of valve assembly 8, unlike prior designs. Further, the ability to immediately replace clip 50 reduces the risk that an operator will forget to place valve assembly 8 back into normal operating mode.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A temperature limiting valve assembly, comprising:
a valve body, the valve body having a housing defining at least one inlet and at least one outlet, a valve member arranged within the housing and operable to control a flow along a flow path between the at least one inlet and the at least one outlet, and a valve stem, the valve stem mechanically coupled to the valve member to position the valve member in a desired positioned relative to the flow path, wherein the valve stem defines a first abutment surface; and
a limiting arrangement, comprising:
a limiting member surrounding the valve stem, the valve stem linearly and rotationally movable within a cavity defined by the limiting member;
a clip removably attachable to said limiting member, the clip defining a second abutment surface, the second abutment surface arranged for abutment with the first abutment surface of the valve stem at a limit position to prevent continued linear movement in a first direction of said valve stem within the cavity of the limiting member.

2. The temperature limiting valve assembly of claim 1 wherein the at least one inlet includes a hot water inlet and a cold water inlet, wherein hot water from the hot water inlet and cold water from the cold water inlet are mixed within the valve body to produce an outlet flow at the at least one outlet, wherein a temperature of the output flow is determined by the position of the valve stem relative to the housing.

3. The temperature limiting valve assembly of claim 2, wherein the limit position defines a maximum temperature of the output flow.

4. The temperature limiting valve assembly of claim 1, wherein the valve stem has a first diameter and a second diameter less than the first diameter, and wherein the first abutment surface is defined at a transition from the first diameter to the second diameter.

5. The temperature limiting valve assembly of claim 4, wherein the clip includes a valve stem receiving portion, the valve stem receiving portion defining a third diameter which is less than the first diameter and greater than the second diameter.

6. The temperature limiting valve assembly of claim 5, wherein the clip is resiliently deformable to an expanded position.

7. The temperature limiting valve assembly of claim 6, wherein in the expanded position, the valve stem receiving portion defines a fourth diameter which is at least as large as the first diameter.

8. The temperature limiting valve assembly of claim 1, wherein the limiting member has a generally cylindrical outer periphery and includes a pair of opposed slots formed in said generally cylindrical outer periphery.

9. The temperature limiting valve assembly of claim 8, wherein the clip has an open side such that it has a pair of opposed leg portions.

10. The temperature limiting valve assembly of claim 9, wherein the pair of opposed leg portions are received, respectively, in the pair of opposed slots of the limiting member.

11. The temperature limiting valve assembly of claim 10, wherein the clip includes a valve stem receiving portion, wherein the valve stem receiving portion is formed between the pair of opposed leg portions.

12. The temperature limiting valve assembly of claim 11, wherein the pair of opposed leg portions are resiliently deformable toward and away from one another to vary a size of the valve stem receiving portion.

13. A temperature limiting valve assembly, comprising:
a valve body, the valve body having a housing defining at least one inlet and at least one outlet, a valve member arranged within the housing and operable to control a flow along a flow path between the at least one inlet and the at least one outlet, and a valve stem, the valve stem mechanically coupled to the valve member to position the valve member in a desired positioned relative to the flow path, wherein the valve stem defines a first abutment surface;
a limiting arrangement, comprising:
a limiting member surrounding the valve stem, the valve stem linearly and rotationally movable within a cavity defined by the limiting member;
a clip, the clip defining a second abutment surface, wherein the clip is resiliently deformable to prevent movement of the first abutments surface past the second abutment surface in a first direction and permit movement of the first abutment surface past the second abutment surface in a second direction opposite the first direction.

14. The temperature limiting valve assembly of claim 13, wherein the clip is resiliently deformable to an expanded position.

15. The temperature limiting valve assembly of claim 14, wherein in the expanded position, a diameter of a valve stem receiving portion of the clip increases.

16. The temperature limiting valve assembly of claim 15, wherein the valve stem has a first diameter and a second diameter less than the first diameter, and wherein the first abutment surface is formed at a transition from the first diameter to the second diameter, wherein when not in the expanded position, a portion of the valve stem defining the first second diameter passes through the clip.

17. The temperature limiting valve assembly of claim 13, wherein the clip is removably mounted relative to the limiting member.

18. A temperature limiter for a valve, the temperature limiter comprising:
a limiting member, the limiting member defining an internal cavity, the internal cavity configured for receipt of a valve stem of the valve; and
a clip removably mounted relative to the limiting member, the clip having an installed position and an uninstalled position, wherein in the installed position, an abutment surface of the clip is positioned within the internal cavity and is arranged to prevent linear movement of the valve stem in a first direction past a limit position, and wherein in the uninstalled position, the abutment surface is not positioned within the internal cavity.

19. The temperature limiting valve assembly of claim 18, wherein the limiting member has a generally cylindrical outer periphery and includes a pair of opposed slots formed in said generally cylindrical outer periphery.

20. The temperature limiting valve assembly of claim 19, wherein the clip has an open side such that it has a pair of opposed leg portions, wherein the pair of opposed leg portions are received, respectively, in the pair of opposed slots.
